(19) United States
(12) Patent Application Publication
(10) Pub. No.: US 2025/0326333 A1
(43) Pub. Date: Oct. 23, 2025

(54) MECHANISM FOR DISPLACING A PART OF A SEAT AND A SEAT COMPRISING SUCH A MECHANISM

(71) Applicant: FAURECIA Sièges d'Automobile, NANTERRE (FR)

(72) Inventors: Julien TANGUY, Le Vey (FR); Denis RICHARD, SAINT MARTIN DE FONTENAY (FR)

(21) Appl. No.: 19/186,989

(22) Filed: Apr. 23, 2025

(30) Foreign Application Priority Data
Apr. 23, 2024 (FR) 2404180

(51) Int. Cl. B60N 2/16; B60N 2/02

(52) U.S. Cl. CPC B60N 2/165; B60N 2/02246

(57) ABSTRACT

The present disclosure relates to a drive mechanism able to displace a part of a vehicle seat, where the drive mechanism comprises:
a side plate provided with a through opening having a first transverse axis;
a centering element comprising a through opening, where the centering element is fixed to the side plate, and where the through opening is centered on the first transverse axis;
a drive member passing through the through opening of the side plate and the through opening of the centering element, where the drive member is pivotable around the first transverse axis, and where the drive member comprises a first toothed stage engaging with the centering element, and a second toothed stage having a different shape from the first toothed stage, where the second toothed stage is coaxial and secured to the first toothed stage.

### PRIORITY CLAIM

This application claims priority to French Patent Application No. FR 2404180, filed A pril 23, 2024, which is expressly incorporated by reference herein.

### BACKGROUND

The present disclosure relates to a mechanism for driving a part of a seat, and in particular, a mechanism for adjusting the height of the seat bottom of a seat. The present disclosure also relates to a seat for an automotive vehicle.

### SUMMARY

According to the present disclosure, a drive mechanism is able to displace at least one part of a seat, specifically a vehicle seat, where the drive mechanism comprises:
a side plate provided with a through opening having a first transverse axis;
a centering element comprising a through opening, where the centering element is fixed to the side plate, and where the through opening is centered on the first transverse axis;
a drive member passing through the through opening of the side plate and the through opening of the centering element, where the drive member is pivotable around the first transverse axis, and where the drive member comprises a first toothed stage engaging with the centering element, wherein it comprises a second toothed stage having a different shape from the first toothed stage, where the second toothed stage is coaxial and secured to the first toothed stage, and where the second toothed stage is intended to engage with a toothed element for displacing the at least one seat part.

Advantageously, the centering element may be used with different toothed elements. When a maker imposes a new toothed element for a part of a seat, only the second toothed stage of the drive member should be modified.

The features disclosed in the following paragraphs may, optionally, be implemented. They may be implemented independently of each other or in combination with each other:
the centering element comprises a plate comprising the through opening and a bearing rotatably mounted in the through opening of the plate, where the bearing further comprises a disk provided with a central hole and teeth arranged along the inner edge of the central, and where the teeth of the bearing engage with the teeth of the first toothed stage;
the plate further comprises a guiding flange bordering the through opening, where the guiding flange is suited for guiding the bearing during rotation thereof around the first transverse axis;
the drive member is made of metal and the bearing is made of plastic;
the plate comprises a first main surface provided with the guiding flange, and a second main surface opposite the first main surface, where the second main surface comprises a housing open to the outside and surrounding the central opening; the disk being mounted rotationally mobile in the housing;
the second toothed stage has at least one shape feature different from a shape feature of the first toothed stage, where the shape feature is a number of teeth and/or shape of the teeth and/or different dimensional features;
the different dimensional features comprise at least one dimension among the pitch, head diameter, foot diameter, the space-width dimension, the angle between two opposite sides forming the summits of the teeth, the foot surface and the head surface.

The subject of the present disclosure is also a seat, in particular a vehicle seat, comprising:
a drive mechanism conformed according to one of the characteristics mentioned above;
at least one pair of track elements;
a seat bottom borne by the at least one pair of track elements;
a seat back borne by the seat bottom, where the seat bottom comprises a seat bottom chassis, and where the seat bottom chassis comprises the side plate extending along a longitudinal direction, where a crosspiece extends along a transverse direction, and where a toothed element engages with the second toothed stage, and where the rotation of the drive member displaces the seat bottom chassis along a vertical direction;
the toothed element comprises at least one control rod provided with a toothed sector, where the control rod is pivotably articulated around a second transverse axis relative to the side plate and around a third transverse axis relative to the track element, where the second transverse axis is the pivoting axis of the toothed sector; the rotation of the drive member pivots the control rod around the second transverse axis and third transverse axis;
the toothed element comprises a rack.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a schematic view of a vehicle seat provided with a drive mechanism according to the present disclosure, the drive mechanism and actuated manually, and a vehicle seat provided with a drive mechanism according to the present disclosure, and where the drive mechanism is motorized;

FIG. 2 is a perspective view of a part of a seat bottom chassis of a seat according to a first embodiment, where the seat bottom chassis is provided with a drive mechanism according to the present disclosure;

FIG. 3 is another perspective view of a part of the chassis shown in FIG. 2;

FIG. 4 is another perspective view of a part of a chassis shown in FIG. 2, in which the drive mechanism is partially pulled free;

FIG. 5 is a perspective view of a drive member of a drive mechanism according to the present disclosure;

FIG. 6 is a perspective view of a drive member assembled to a centering element of a drive mechanism according to the present disclosure;

FIG. 7 is an exploded perspective view of the drive member and of the centering element shown in FIG. 6; and

FIG. 8 is a perspective view of a part of a seat bottom chassis of a seat according to a second embodiment, where the seat bottom chassis is provided with a drive mechanism according to the present disclosure;

### DETAILED DESCRIPTION

In the following description, when referring to absolute position qualifiers, such as the terms “front,” “rear,” “top,” “bottom,” “left,” “right,” etc., or relatives such as the terms “above,” “below,”, “upper,” “lower,” etc. or orientation qualifiers, such as “horizontal,” “vertical,” etc., unless indicated otherwise refer to the orientation of the figures or of a seat in the normal position of use thereof.

In the remainder, the longitudinal direction X means the longitudinal direction of the seat. The longitudinal direction of the seat is considered to be the same as the longitudinal direction of the automotive vehicle in which the seat is mounted. This longitudinal direction corresponds to the normal direction of forward motion of the vehicle. The longitudinal direction X is preferably horizontal. The transverse direction Y is the transverse direction of the seat. The transverse direction Y of the seat thus corresponds to the transverse or lateral direction of the automotive vehicle. This transverse direction Y corresponds to a direction perpendicular to the normal direction of forward motion of the vehicle. The transverse direction Y is preferably horizontal.

Finally, the vertical direction Z is a vertical direction of the seat, perpendicular to the longitudinal X and transverse Y directions.

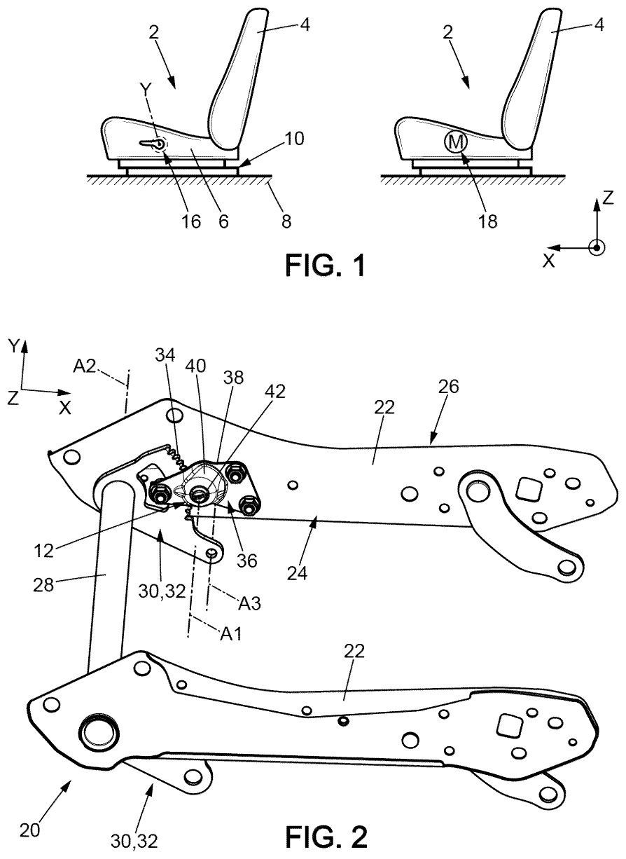

FIG. 1 represents a vehicle seat 2 which comprises a seat bottom 6 and a seatback 4 borne by the seat bottom 6, and two pairs of track elements 10, mounted on the floor 8 of the vehicle.

The pairs of track elements 10 extend along a longitudinal direction X. One track element of each pair is mounted sliding in another track element of the same pair.

The seat bottom 6 includes a seat bottom chassis 20 partially shown in FIG. 2. The seat bottom chassis 20 comprises two side plates 22 each extending in the longitudinal direction X and comprising, along the transverse direction Y, an inner side 24 and an outer side 26. The seat bottom chassis 20 comprises at least one tubular cross piece 28 extending along the transverse direction and secured on each side of each of the side plates. Referring to FIG. 4, the side plates 22 comprise a through opening 29 arranged around the first transverse axis A1.

The seat bottom chassis 20 further comprises toothed elements 30 arranged from the inner side 24 of the side plates along the transverse direction. In the embodiment shown in FIGS. 2 to 4, the toothed elements 30 are connecting rods 32 hinged pivoting on the cross piece 28 around a second transverse axis A2 relative to the side plates. The connecting rods 32 each comprised a toothed sector 34 pivotable around a point of the second transverse axis A2. The connecting rods 32 are further hinged around a third transverse axis A3 to a part, fixed in height, of one element of the pair of track elements 10. The part of this element fixed in height is not shown in the figures.

The seat 2 further comprises a drive mechanism 12 connected to the seat bottom with which to adjust the height of the seat. The drive mechanism 12 may be driven by a command lever 16 mounted pivoting around a transverse horizontal axis of rotation as shown in FIG. 1. The drive mechanism 12 may also be motorized and actuated by an actuator 18. The drive mechanism 12 comprises a first case 36 arranged on the inner side 24 of the side plate along the transverse direction. The first case 36 comprises a main wall 38 extending substantially perpendicularly to the transverse direction Y. The main wall 38 comprises a cap 40 extending along the transverse direction Y in a direction oriented towards the side opposite to the side plate 22. The cap 40 is provided with an opening 42. The toothed sector 34 of the connecting rod is arranged transversely between the main wall 38 and the inner side 24 of the side plate.

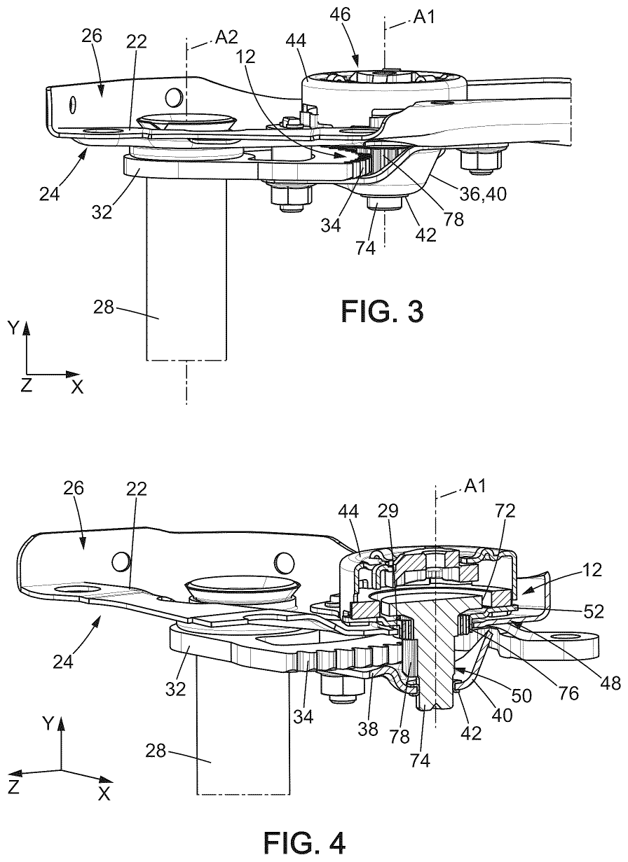

Referring to FIGS. 3 and 4, the drive mechanism 12 comprises a second case 44 arranged on the outer side 26 of the side plate along the transverse direction, and an adjustment mechanism 46 housed in the second case 44.

The drive mechanism 12 further comprises a centering element 48 and a drive member 50.

The centering element 48 is arranged transversely between the second case 44 and the outer side 36 of the side plate 22. The centering element 48 serves to guide and center of the drive member 50. The centering element 48 also makes it possible to attach the first case 36 to the side plate 22.

Referring to FIGS. 6 and 7, the centering element 48 comprises a plate 52 and a bearing 54.

The plate 52 comprises a through opening 56 having a center centered on the first transverse axis A1. The plate 52 is attached to the side plate 22 and to the first case 36 for example by means of bolts. The plate 52 comprises a first main surface 58 arranged facing the outer surface 26 of the side plate. The first main surface 58 of the plate comprises a guiding flange 60 bordering the through opening 56 and extending along the transverse direction Y in a direction directed towards the first case 36. The plate comprises a second main surface 62 opposite the first main surface 58. The second main surface 62 comprises a housing 64 open on the outside and surrounding the central opening 56.

The bearing 54 is mounted rotationally mobile in the through opening 56 of the plate. The bearing 54 comprises a disk 66 provided with a central hole 68. The disk 66 is housed rotationally mobile in the housing 64. The bearing comprises a plurality of teeth 70. The teeth 70 are distributed uniformly around the inner edge of the central hole. The teeth 70 of the bearing comprised an inner convex surface and an outer rounded surface engageable with the inner surface of the guiding flange.

Preferably, the plate 52 is made of plastic. Preferably, the bearing 54 is made of plastic.

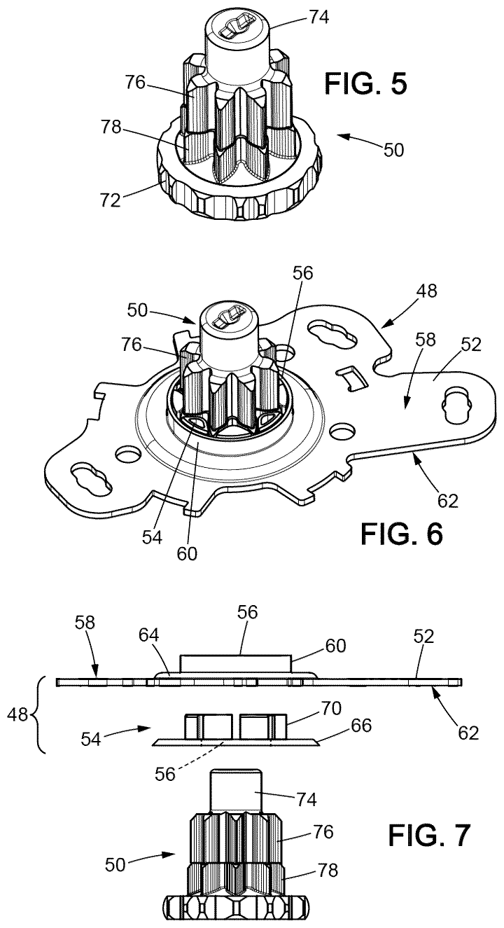

Referring to FIGS. 4, 5 and 7, the drive member 50 extends along the first transverse axis A1. The drive member 50 comprises a fluted shaft 72 at one end thereof and a smooth rod 74 at the other end thereof. The fluted shaft is housed in part in the housing 64 of the plate of the centering element. The fluted shaft 72 is held with a fluted hole of a ring of the adjustment mechanism 46 such that the drive member 50 is rotated around the first transverse axis A1 during actuation of the adjustment mechanism.

The drive member 50 extends along the first transverse axis A1 through the central hole 68 of the bearing, the through opening 56 of the side plate, and the opening 42 of the first case. The drive member 50 further comprises a first toothed stage 76. The first toothed stage has the shape of a first toothed wheel. The first toothed stage 76 engages with the centering element 48. In particular, the teeth of the first toothed stage mesh with the teeth 70 of the bearing 54 of the centering element. The drive member 50 further comprises a second toothed stage 78. The second toothed stage 78 also has the shape of a second toothed wheel. The second toothed stage 78 is coaxial and secured to the first toothed stage. Thus, the first toothed wheel and the second toothed wheel are secured. The first toothed wheel and the second toothed wheel are also coaxial and contiguous. The second toothed stage 78 engages with the toothed sector 34 of the connecting rod 32.

The second toothed stage 78 has a different shape than the first toothed stage 76. In particular, the second toothed stage 78 has at least one shape feature different from a shape feature of the first toothed stage. The different shape features may for example be the number of teeth and/or shape of the teeth and/or different dimensional features.

For example, the dimensional features comprise at least one dimension among the pitch of the teeth, head diameter, foot diameter, the dimension of the space between consecutive teeth, the angle between two opposite sides forming the summits of the teeth, the foot surface area and the head surface area.

The pitch of the teeth is the distance between two right sides or two left sides of two consecutive teeth. The head diameter is the diameter of a circle which passes through the top of the teeth. The foot diameter is the diameter of a circle which passes through the base of the teeth. The dimension between two consecutive teeth is called the space width.

The fluted shaft and a portion of the first toothed stage 76 are arranged from the outer side 26 of the side plate. The other portion of the first toothed stage 76, the second toothed stage and the smooth rod 74 are arranged from the inner side 24 of the side plate. The second toothed stage 78 engages with the toothed wheel 34 of the connecting rod 32. The smooth rod 74 is mounted rotationally free in the opening 42 of the first case.

Preferably, the drive member 50 is made of metal.

Functionally, when the adjustment mechanism 12 is actuated manually by the lever 16 or by the actuator 18, the drive member 50 is rotated around the first transverse axis A1. The second toothed stage 78 meshes with the toothed sector 34. The connecting rod 32 pivots around the second transverse axis A2 and the third transverse axis A3. The pivoting of the control rod 32 raises or lowers the side plates 22, the cross piece 28 and therefore the seat bottom 6 of the seat.

As a variant, the toothed element may be a pinion.

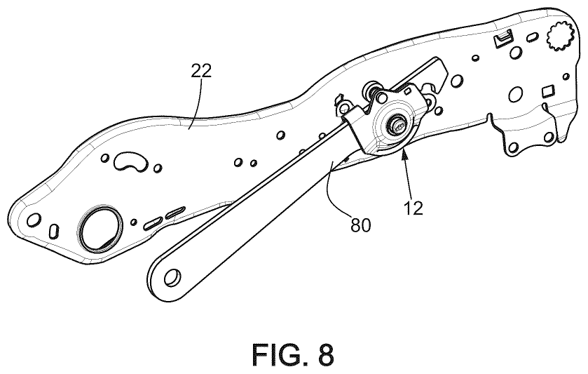

According to a second embodiment, the toothed element is a rack. FIG. 8 shows a portion of a chassis of a seat according to this second embodiment of the present disclosure. This second embodiment is identical to the first embodiment of the present disclosure except that the connecting rod 32 has been replaced by a rack 80. The rack is mounted pivoting around a transverse axis relative to an element of the slider 10.

When the drive mechanism 12 is actuated, the drive member is rotated about the second transverse axis A2. The second toothed stage 78 of the drive member meshes with the teeth of the rack. The rack pivots and lifts the seat bottom chassis of the seat.

The drive mechanism 12 according to the present disclosure may also be applied to other mobile elements of the seat such as an adjustment mechanism for the height of the headrest.

In the field of automotive vehicles, the shape of the parts of the chassis of a seat may sometimes be imposed by the manufacturer of the vehicle such that some mechanical parts which are in contact with mechanical parts of the chassis should be modified to allow execution of some function.

The mechanism for driving the seat may sometimes be implemented by a different maker than the maker manufacturing the chassis of the seat. The mechanism for adjusting the height of the seat may for example comprise a specific drive member meshable with a toothed sector of a connecting rod or on a rack. Hence, when a maker imposes a specific shape for the teeth of the toothed sector or a specific shape for the teeth of the rack, the drive member and the centering element of the drive mechanism should be modified in order to allow engaging of the teeth of the drive member against the toothed sector or the rack. Also, the toothing of the bearing for the centering element should be modified to allow meshing thereof with the new drive member. These changes are costly. These changes require the management of many different part numbers.

The first goal of the present disclosure is to propose a drive mechanism having a larger number of standard parts.

A second goal of the present disclosure is to reduce the manufacturing cost of a drive mechanism. In particular, the goal of the present disclosure is to reduce the manufacturing cost of a mechanism for adjusting the height of a seat.

The goal of the present disclosure is a drive mechanism able to displace at least one part of a seat, specifically a vehicle seat, where the drive mechanism comprises:
a side plate provided with a through opening having a first transverse axis;
a centering element comprising a through opening, where the centering element is fixed to the side plate, and where the through opening is centered on the first transverse axis;
a drive member passing through the through opening of the side plate and the through opening of the centering element, where the drive member is pivotable around the first transverse axis, and where the drive member comprises a first toothed stage engaging with the centering element, wherein it comprises a second toothed stage having a different shape from the first toothed stage, where the second toothed stage is coaxial and secured to the first toothed stage, and where the second toothed stage is intended to engage with a toothed element for displacing the at least one seat part.

Advantageously, the centering element may be used with different toothed elements. When a maker imposes a new toothed element for a part of a seat, only the second toothed stage of the drive member should be modified.

The features disclosed in the following paragraphs may, optionally, be implemented. They may be implemented independently of each other or in combination with each other:
the centering element comprises a plate comprising the through opening and a bearing rotatably mounted in the through opening of the plate, where the bearing further comprises a disk provided with a central hole and teeth arranged along the inner edge of the central, and where the teeth of the bearing engage with the teeth of the first toothed stage;
the plate further comprises a guiding flange bordering the through opening, where the guiding flange is suited for guiding the bearing during rotation thereof around the first transverse axis;
the drive member is made of metal and the bearing is made of plastic;
the plate comprises a first main surface provided with the guiding flange, and a second main surface opposite the first main surface, where the second main surface comprises a housing open to the outside and surrounding the central opening; the disk being mounted rotationally mobile in the housing;
the second toothed stage has at least one shape feature different from a shape feature of the first toothed stage, where the shape feature is a number of teeth and/or shape of the teeth and/or different dimensional features;
the different dimensional features comprise at least one dimension among the pitch, head diameter, foot diameter, the space-width dimension, the angle between two opposite sides forming the summits of the teeth, the foot surface and the head surface.

The subject of the present disclosure is also a seat, in particular a vehicle seat, comprising:
a drive mechanism conformed according to one of the characteristics mentioned above;
at least one pair of track elements;
a seat bottom borne by the at least one pair of track elements;
a seat back borne by the seat bottom, where the seat bottom comprises a seat bottom chassis, and where the seat bottom chassis comprises the side plate extending along a longitudinal direction, where a crosspiece extends along a transverse direction, and where a toothed element engages with the second toothed stage, and where the rotation of the drive member displaces the seat bottom chassis along a vertical direction;
the toothed element comprises at least one control rod provided with a toothed sector, where the control rod is pivotably articulated around a second transverse axis relative to the side plate and around a third transverse axis relative to the track element, where the second transverse axis is the pivoting axis of the toothed sector; the rotation of the drive member pivots the control rod around the second transverse axis and third transverse axis;
the toothed element comprises a rack.

The present disclosure relates to a drive mechanism able to displace a part of a vehicle seat, where the drive mechanism comprises:
a side plate provided with a through opening having a first transverse axis;
a centering element (48) comprising a through opening (56), where the centering element is fixed to the side plate, and where the through opening is centered on the first transverse axis;
a drive member (50) passing through the through opening of the side plate and the through opening (56) of the centering element, where the drive member (50) is pivotable around the first transverse axis, and where the drive member comprises a first toothed stage (76) engaging with the centering element, and a second toothed stage (78) having a different shape from the first toothed stage, where the second toothed stage is coaxial and secured to the first toothed stage.

1. A drive mechanism able to displace at least one part of a seat, specifically a vehicle seat, where the drive mechanism comprises:
a side plate provided with a through opening having a first transverse axis;
a centering element comprising a through opening, where the centering element is fixed to the side plate, and where the through opening is centered on the first transverse axis;
a drive member passing through the through opening of the side plate and the through opening of the centering element, where the drive member is pivotable around the first transverse axis, and where the drive member comprises a first toothed stage engaging with the centering element, wherein it comprises a second toothed stage having a different shape from the first toothed stage, where the second toothed stage is coaxial and secured to the first toothed stage, and where the second toothed stage is intended to engage with a toothed element for displacing the at least one seat part.

2. The drive mechanism according to claim 1, wherein the centering element comprises a plate comprising the through opening and a bearing rotatably mounted in the through opening of the plate, where the bearing further comprises a disk provided with a central hole and teeth arranged along the inner edge of the central hole, and where the teeth of the bearing engage with the teeth of the first toothed stage.

3. The drive mechanism according to claim 2, wherein the plate further comprises a guiding flange bordering the through opening, where the guiding flange is suited for guiding the bearing during rotation thereof around the first transverse axis.

4. The drive mechanism according to claim 2, wherein the drive member is made of metal and the bearing is made of plastic.

5. The drive mechanism according to claim 3, wherein the drive member is made of metal and the bearing is made of plastic.

6. The drive mechanism according to claim 3, wherein the plate comprises a first main surface provided with the guiding flange, and a second main surface opposite the first main surface, where the second main surface comprises a housing open to the outside and surrounding the central opening; the disk being mounted rotationally mobile in the housing.

7. The drive mechanism according to claim 4, wherein the plate comprises a first main surface provided with the guiding flange, and a second main surface opposite the first main surface, where the second main surface comprises a housing open to the outside and surrounding the central opening; the disk being mounted rotationally mobile in the housing.

8. The drive mechanism according to claim 4, wherein the plate comprises a first main surface provided with the guiding flange, and a second main surface opposite the first main surface, where the second main surface comprises a housing open to the outside and surrounding the central opening; the disk being mounted rotationally mobile in the housing.

9. The drive mechanism according to claim 1, wherein the second toothed stage has at least one shape feature different from a shape feature of the first toothed stage, where the shape feature is a number of teeth and/or shape of the teeth and/or different dimensional features.

10. The drive mechanism according to claim 6, wherein the different dimensional features comprise at least one dimension among the pitch, head diameter, foot diameter, the space-width dimension, the angle between two opposite sides forming the summits of the teeth, the foot surface and the head surface.

11. A seat, in particular a vehicle seat, comprising:
the drive mechanism conformed according claim 1;
at least one pair of track elements;
a seat bottom borne by the at least one pair of track elements;
a seat back borne by the seat bottom, where the seat bottom comprises a seat bottom chassis, and where the seat bottom chassis comprises the side plate extending along a longitudinal direction, where a crosspiece extends along a transverse direction, and where a toothed element engages with the second toothed stage, and where the rotation of the drive member displaces the seat bottom chassis along a vertical direction.

12. The seat according to claim 11, wherein the toothed element comprises at least one control rod provided with a toothed sector, where the control rod is pivotably articulated around a second transverse axis relative to the side plate and around a third transverse axis relative to the track element, where the second transverse axis is the pivoting axis of the toothed sector; the rotation of the drive member pivots the control rod around the second transverse axis and third transverse axis.

13. The seat according to claim 11, wherein the toothed element comprises a rack.
